(19) United States
(12) Patent Application Publication
(10) Pub. No.: US 2002/0023233 A1
(43) Pub. Date: Feb. 21, 2002

(54) Methods and apparatus for wireless control of remote devices

(76) Inventor: Francisco O'Meany, Pittsburg, CA (US)

Correspondence Address: H. Michael Brucker, Suite 110, 5855 Doyle Street, Emeryville, CA, 94608, US

(21) Appl. No.: 09/927,104

(22) Filed: Aug. 10, 2001

Related U.S. Application Data
(60) Provisional application No. 60/224,752, filed on Aug. 10, 2000.

(51) Int. Cl. G06F 1/26; G06F 1/28; G06F 1/30

(52) U.S. Cl. 713/300

(57) ABSTRACT

A master controller (computer) using a database of information about remote devices to operate certain activities of the remote devices over a wireless link formed by a signal transmitter which wirelessly relays signals from the master controller to a satellite, which wirelessly relays the signal to a transmitter tower, which wirelessly relays the signal to a signal receiver, which directs the signal to an intelligent agent (computer) which has two-way communication with one or more of the remote devices.

### BACKGROUND AND SUMMARY OF THE INVENTION

The present invention relates to methods and apparatus for the remote wireless control of devices, such as computers, where the devices being controlled actively participate in the control process.

The wireless remote control of devices has long been practiced using radio waves, up-links and down-links from satellites, and other ways of transmitting information wirelessly.

The present invention teaches methods and apparatus for the remote wireless control of one or more devices where the device(s) being controlled is in two-way communication with an intelligent agent (IA) resident where the wireless signal is received. As used herein, an intelligent agent is a computer, usually contained on a single board. A local IA is in two-way communication with the device being controlled, which enables the device to participate in the control process. The communication link between the device and the IA can be wireless or wired.

In general, the method of the invention is wirelessly controlling one or more remote devices to be controlled, including the steps of: generating a device control signal; wirelessly transmitting the device control signal to a satellite; wirelessly transmitting the device control signal from the satellite to a control signal transceiver; distributing the control signal from the transceiver to the device to be controlled; transmitting a signal from the device to be controlled to the transceiver indicating that the device to be controlled is ready to be controlled; and then generating a signal that controls some aspect of the device to be controlled.

In the present invention, a master controller (computer) uses a database of information about one or more remote devices to control certain activities of those remote devices over a wireless link formed, for example, by a signal transmitter which wirelessly relays signals from the master controller to a satellite, which wirelessly relays the signal to a transmitter tower, which wirelessly relays the signal to a signal receiver, which directs the signal to a local IA which has two-way communication with one or more of the remote devices to be controlled.

For the purposes of illustration and understanding, the invention is described with reference to remotely controlling the power status of one or more computers and, in particular, remotely disconnecting the computers from their power source and connecting the computers to their power source—turning the computers off and on. It will be immediately obvious to those skilled in the art that controlling other computer functions is well within the scope of the invention, as are the control of functions of other devices such as pumps, generators, etc., as well as monitoring the status of remote devices.

The economic advantages of being able to remotely and wirelessly turn a bank of computers off and on is best understood in the context of large numbers of computers (such as used by banks, insurance companies, government agencies and the like) which are connected by a local area network (LAN) or a wide area network (WAN) and which are subject to personal computer systems management (PCSM) over the LAN or WAN at various irregular times. In order to provide PCSM to the computers on a LAN or WAN, the computers must be up and running. Because PCSM takes place most advantageously when the computers are not in use, it is a common practice for such services to be delivered during late evening or early morning hours when the computers are not in use. At such times, the computers are also unattended. To make sure that the computers are able to receive PCSM, it is now a common practice to leave the computers on all the time—day and night. The combined power usage of a large number of computers is significant and, when left running unattended for many hours just to make sure the computer is able to receive PCSM, which may take only a few minutes, is wasteful of energy and costly.

The present invention provides a solution to the problem that is not only effective in eliminating the unnecessary use of power and reducing administrative costs, but does so in a way that makes economic sense—the cost is quickly recovered by the savings.

Computers cannot be safely turned off by simply switching off power and cannot be turned on by simply switching on power. The present invention provides for remote, orderly shutdown and disconnection from power of one or more computers and the remote connection to power and booting up of one or more computers, all without physical human intervention at the computers. One of the outstanding features of the present invention is that it can operate with almost all computers, old and new alike, so that it is not necessary to replace installed computers with upgrades in order to employ and take advantage of the present invention, which makes old and existing computers “wireless aware,” allowing them to receive wireless instant notifications. A two-way communication link between the computers to be turned off and on and a local IA (which has access to the transmitted signal from the master controller) permits the system to be easily adapted to work with almost any computer and, by knowing the status of those computers, transfer the correct control signals. The IA also operates to provide security so that only authorized signals can reach and control the devices.

Accordingly, it is an object of the present invention to provide a wireless control system and methods of operating same wherein the devices being controlled are in two-way communication with a local IA that has access to the wirelessly transmitted control signals.

It is another object of the present invention to provide methods and apparatus for the wirelessly remote control of the power status of a plurality of computers by which the computers can be turned off and on in a manner compliant with the needs of the computer and without physical human intervention at the computers.

Still other objects and advantages of the present invention, such as Uninterrupted Power Source (UPS) wireless notification, will become readily apparent to those skilled in this art from the following detailed description wherein I have shown and described only the preferred embodiments of the invention simply by way of illustration of the best mode contemplated by me of carrying out my invention. As will be realized, the invention is capable of modifications in various obvious respects, all without departing from the invention. Accordingly, the drawings and descriptions are to be regarded as illustrative in nature, and not as restrictive.

### BRIEF DESCRIPTION OF THE DRAWINGS

FIG. 1 is a schematic illustration of the invention wherein a single device (computer) is being controlled.

FIG. 2 is a schematic illustration of the invention wherein a plurality of devices (computers) are being controlled.

FIG. 3 is a schematic illustration of the internal power relay of a computer; and

FIG. 4 is schematic illustration of the invention in which the local controller is freestanding.

### DETAILED DESCRIPTION OF THE PREFERRED EMBODIMENTS

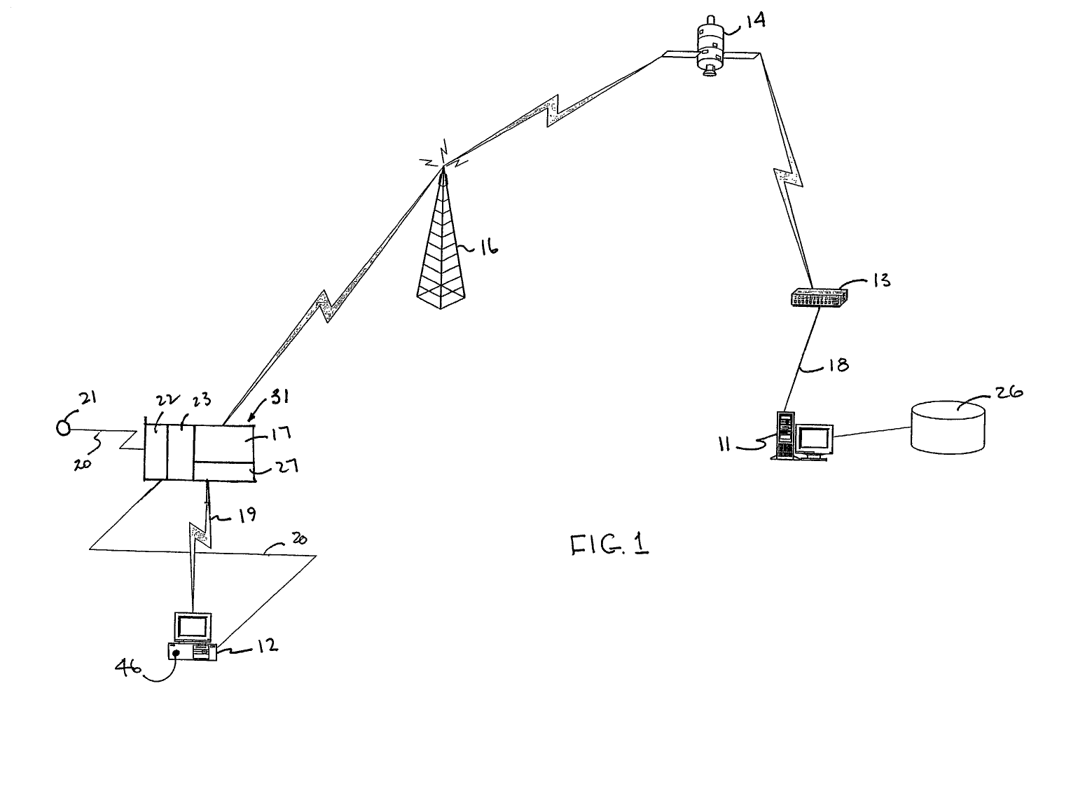

Referring to FIG. 1, a master controller (MC) computer 11 controls the power status—connected to power or disconnected from power—of a remotely located controlled (RLC) computer 12 over a wireless transmission link formed, for example, by a signal transmitter 13, a satellite 14, a wireless signal transmitter tower 16 and a wireless signal receiver 17. The wireless signal transmitter 13 transmits a signal to the satellite 14 (up-link), which retransmits the signal to the wireless signal transmitter tower 16 (down-link), which wirelessly transmits the signal to a wireless signal receiver 17. A control signal generated by the MC computer 11 is delivered to the wireless signal transmitter 13 over a wired connection 18. The control signal received by the wireless signal receiver 17 can be transmitted by a local transmitter 27 to the RLC computer 12 by a two-way communication link 19 that can be either wired or wireless.

An electrical power source 21 provides power over line 20 to the RLC computer 12 through a power relay (switch) 22. An IA 23 is operatively connected to the receiver 17, the transmitter 27 and the relay 22. The IA 23 controls the status of relay 22 (opened or closed), and thereby controls whether or not power is available to RLC computer 12. IA 23 also determines what received signals from MC computer 11 are delivered to RLC computer 12.

The wireless signal receiver 17, the local transmitter 27, the IA 23 and the power relay 22 together form a local controller unit 31 which can be conveniently packaged into a single unit.

A controlled computer database 26 contains control signal data particular to RLC computer 12 and is available to MC computer 11, permitting it to generate and transmit signals which can be understood and acted on by IA 23 and RLC computer 12.

Assuming that RLC computer 12 is receiving power from the power source 21 (power relay 22 closed and computer 12 is on), the MC computer 11 operates to shut down the controlled computer 12 as follows. Using the information in controlled computer database 26, MC computer 11 generates a shutdown signal which will be understood as such by RLC computer 12. The shutdown signal is transmitted via link 18 to wireless signal transmitter 13, where it is Tirelessly transmitted to satellite 14, which wirelessly transmits it to wireless signal transmitter tower 16, which wirelessly relays it to wireless signal receiver 17 from which it is available to IA 23.

In the preferred embodiment, IA 23 performs a security function to assure that the signal is authorized and received at a time when it can be acted on. If encrypted, the IA 23 also unencrypts the signal. If the signal passes security, it is retransmitted by signal generator 27 to RLC computer 12 over link 19 (which can be wireless or wired, as described in greater detail below). The signal causes RLC computer 12 to initiate its orderly shutdown routine, at the end of which it produces a signal indicating that it is ready to be shut down safely. This safe-to-shut-down signal is transmitted through link 19, where it is received by IA 23, which then, and only then, directs relay 22 to open and disconnect power source 21 from RLC computer 12.

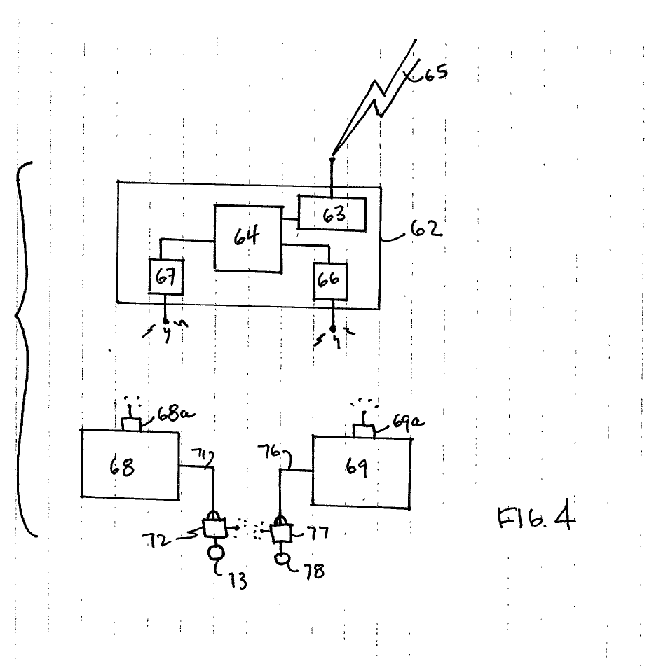

Referring to FIG. 3, many present day computers 36 have built-in Advanced Configuration Power Interface (ACPI) 37 which, at the end of the orderly shutdown procedure, transmits a signal via line 39 that activates the computer's internal power relay 38 to disconnect the power source 41 from the computer 36. Other computers, especially older ones, require the human physical act of actuating power relay 38 once the orderly shutdown procedure is completed in order to disconnect the power from the computer. In both cases, internal relay 38 is actuated (opened) and the physical act of a human is required to actuate the relay actuator 42 (close it) to connect the power source 41 back to the computer so it can boot up. One of the objects of the present invention is to remotely, and without human physical presence, turn the computer on, as well as off.

Referring once again to FIG. 1, in the case of a computer 12 with ACPI, the signal from the MC computer 11 includes a command that temporarily disables the ACPI before the shutdown signal is delivered. This results in the computer acting like computers without ACPI—announcing when it is safe to turn off the power, but not taking the step of actuating the computer's internal power relay 46. For computers without ACPI, the ACPI disabling signal is not included. ACPI can later be enhanced by using this invention, integrating its components in a computer motherboard.

Once the IA 23 receives the signal that the RLC computer 12 can be safely disconnected from power 21, the relay 22 (not the computer's internal power relay 41 which now stays closed all the time) is actuated and the power from source 21 is disconnected from RLC computer 12. When it comes time to turn RLC computer 12 on, a wireless signal from MC computer 11 tells IA 23 that relay 22 is to be actuated and, after qualifying the signal, causes relay 22 to close and deliver power over line 20 to RLC computer 12. Because the internal relay switch 46 of RLC computer 12 has remained closed, it is not necessary for a human to actuate that relay in order for the computer to receive power from source 21 and boot up.

Critical to the orderly shutdown of RLC computer 12 is the two-way communication link 19 which both transmits the command to RLC computer 12 to start the shutdown procedure, as well as transmits the signal from RLC computer 12 to IA 23 that the shutdown procedure has been completed and RLC computer 12 can be safely disconnected from power.

One of the outstanding features of the present invention is that the local controller 31 operates independently of the particular specifications of RLC computer 12. The commands which are generated by MC computer 11 based on specifications provided by database 26 are, in essence, only passed through local controller 31 which itself does not have to store or have knowledge of the command parameters of RLC computer 12. In this way, local controller 31 is truly universal and need not be specifically configured to every different RLC computer 12 with which it operates.

The invention is also scaleable in that a single local unit 31 can, by multiplying the number of power relays 22, serve to facilitate an orderly shutdown and power-up of a plurality of controlled computers wherein each controlled computer can be independently addressed to be turned on or off.

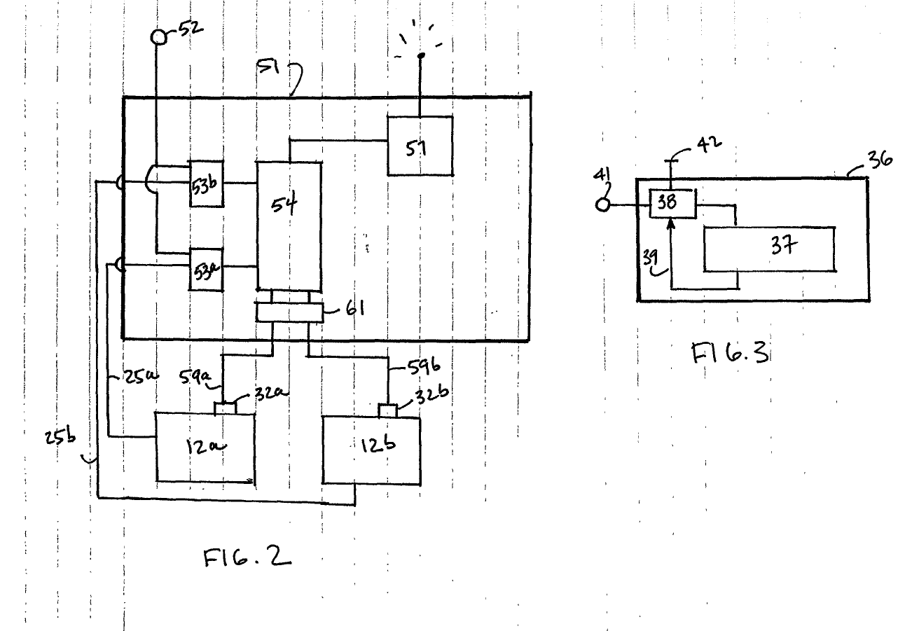

Referring to FIG. 2, as well as FIG. 1, an RLC computer 12a has a power cord 25a which is plugged into a local controller unit 51 which connects it to the power source 52 through a relay 53a. A second RLC computer 12b has its power cord 25b plugged into local controller unit 51 and to the power source 52 through relay 53b. A two-way communication link 19a connects RLC computer 12a to IA 54, while a two-way communication link 19b connects RLC computer 12b to IA 54. The local controller unit also includes a signal receiver 57 which receives control signals generated by MC computer 11.

When MC computer 11 (FIG. 1) controls more than one RLC computer 12 through a single local controller, such as local controller 52, its associated controlled computers database 26 includes, in addition to the control signals for the particular computers being controlled, an address signal which essentially uniquely addresses each computer to be controlled. Each relay 53a and 53b, as well as each transmission link 59a and 59b between IA 54 and RLC computers 12a and 12b, respectively, is addressable through IA 54.

When a control signal is received by wireless signal receiver 57, IA 54 determines from the included address signal which of transmission links 59a or 59b (or both) to direct it to and thereby which of computers 12a or 12b is to receive a control signal and be disconnected from power. In the case of a shutdown command, if the IA 54 determines that the signal is directed to transmission link 59a, it sends the signal over that link to RLC computer 12a to start its orderly shutdown procedure, as previously described. When RLC computer 12a has completed that process, it signals IA 54 via link 59a that the procedure has been completed, and IA 54 then activates relay 53a, disconnecting the power to RLC computer 12a. Similarly, a signal addressed to transmission link 59b will be directed only to RLC computer 12b and operate only relay 53b which controls the power to RLC computer 12b. While the embodiment of FIG. 2 illustrates only two computers—12a and 12b—the control of a greater number of computers requires only additional relays 53 and two-way communication links 59 in order to accommodate a greater number of computers. Where the number of computers being controlled is large, MC computer 11 can sequence the transmission of the signals for connecting and disconnecting the computers so that they do so in a timed fashion and do not cause an overload of the power source 52.

As previously mentioned, the two-way communication links 59a and 59b that deliver signals between the computers and IA 54 can be either wired or wireless. Where the two-way communication links 59a and 59b are wired, cables run from each RLC computers 12a and 12b to the local controller 51, where they connect to IA 54.

Where the two-way communication links 59a and 59b are wireless, each of RLC computers 12 and 12b are equipped with an external wireless transceiver 32a and 32b, respectively, which are commercially available and which can be connected to a computer through either a serial port or a USB port. Significantly, the transceivers can be operatively connected to a computer without having to open the computer and access its internal parts. Each of the transceivers 32a and 32b is individually addressable so that a signal directed to RLC computer 12a is received and acted upon only by transceiver 32a and ignored by transceiver 32b of RLC computer 12b, and vice versa. Once again, the address information required to communicate wirelessly between IA 54 and RLC computers 12a and 12b on an individual basis is stored in the computers database 26 (FIG. 1) and not within local controller 51, thereby maintaining local controller 51 universal, as previously described.

A local controller transceiver 51 wirelessly transmits and receives signals to and from computer transceivers 32a and 32b. Each computer transceiver 32a and 32b transmits a unique signal that enables IA 54 to distinguish information received from each computer being controlled from the other computers being controlled.

The universality of the of the local controller unit 51 derives from the fact that control signals from MC computer 11 addresses relays and transmission links internal to the local controller unit 51. The IA 54 routes a signal according to the signal's address code without having to know anything about the computer or other device which ultimately receives the control signal.

Where the number of devices (computers in the example described) being controlled is large and it becomes unwieldy to bring a power cord from each device to the local controller unit, remote relays at the power source can be utilized.

Referring to FIG. 4, a local controller unit 62 controls the power status of two RLC computers 68 and 69. RLC computer 68 is equipped with an external transceiver 68a for wirelessly receiving and sending signals. Likewise, RLC computer 69 is equipped with an external transceiver 69a for wirelessly receiving and sending signals, as previously described with reference to FIGS. 1-3. In addition, the power cord 71 of RLC computer 68 is plugged into a wireless remote control relay 72 that is electrically interposed between the power source 73 and power cord 71. In the same way, the power cord 76 of RLC computer 69 is plugged into a wireless remote control relay 77 that is electrically interposed between the power source 78 and power cord 76.

Local controller 62 includes a signal receiver 63 which delivers wireless signals 65 to an IA 64 and two wireless signal generators 66 and 67. Wireless signal generator 66 transmits control signals to RLC computers 68 and 69 via transceivers 68a and 69a, as previously described with reference to FIGS. 1-3. Wireless signal generator 67 produces signals that operate remote relays 72 and 77 to connect and disconnect power to the RLC computers 68 and 69.

While the example of FIG. 4 describes a system with two computers being controlled, there is nothing to prevent many more computers being controlled from the same unit 62. The IA 64 directs signals to the appropriate computer and relay based on the address signal contained in the control signal from the master controller computer.

Because the local controller unit 62 is freestanding—requires no wired connections to the computers being controlled or their respective power cords—it is particularly suitable for controlling a large number of computers in relatively close proximity.

In another embodiment of the invention, the internal power relay of the computer itself is designed to be operable by wireless control signals. In this embodiment, the local controller relays 53a and 53b (FIG. 2) and the remote controlled power cord relays 71 and 77 (FIG. 4) are eliminated, as their function is supplied by the computer's own internal remote control power relay.

It will occur to those skilled in the art that by expanding the function of the local signal receiver (e.g., receiver 17) to include wireless signal transmission, the invention can not only control remote devices, but also monitor and report their status.

The hardware and software required to form the systems and perform the methods of the present invention are all well known and either commercially available items or readily programmable by those skilled in the art and therefore have not been described in detail.

Of course, various changes, modifications and alterations in the teachings of the present invention may be contemplated by those skilled in the art without departing from the intended spirit and scope thereof. As such, it is intended that the present invention only be limited by the terms of the appended claims.

1. In a wireless remote control system for controlling power distribution from a power source to a computer the combination comprising:
a master controller computer for generating power distribution signals;
a wireless signal receiver for receiving power distribution signals;
a wireless signal transmission link delivering power distribution signals from said master controller to said wireless signal receiver;
an external power switch disposed between the power source and the computer and having an open condition in which the power source is disconnected from the computer and a closed condition in which the power source is connected to the computer;
an intelligent agent that receives signals from said wireless signal receiver, distributes control signals to and receives signals from the computer to be controlled and controls the condition of said power switch;
a two-way communication link between the computer to be controlled and said intelligent agent over which signals between said intelligent agent and the computer to be controlled are transmitted.

2. The system of claim 1 further comprising a database of information about the controlled computer and used by said master controller computer to generate a computer shutdown control signal that is recognized by the controlled computer.

3. The system of claim 2 wherein the controlled computer responds to a to a computer shutdown signal by executing an orderly shutdown routine and then transmits a signal indicating that it is safe to disconnect the power source from the controlled computer, which signal is transmitted to said intelligent agent.

4. The system of claim 3 wherein said intelligent agent responds to a signal from the controlled computer that it is safe to disconnect the power source from the controlled computer by opening said external power switch and thereby disconnecting the power source from the controlled computer.

5. The system of claim 4 wherein the controlled computer includes an internal power switch that is manually closed to connect power to the controlled computer and includes ACPI which, unless disabled, causes the internal power switch to open automatically after the controlled computer executes its orderly shutdown routine, but which, if disabled, does not automatically open the internal power switch after the controlled computer executes its orderly shutdown routine, but rather issues a signal indicating that it is safe to disconnect the controlled computer from the power source and further comprising:
said master controller transmitting an ACPI disabling signal along with any shutdown signal.

6. The system of claim 4 wherein the signal transmitted by said master controller computer includes security information identifying the control signal as an authorized signal and said intelligent agent only distributes a control signal to the computer to be controlled if the security information is authentic.

7. The system of claim 2 wherein said two-way communication link is a wireless link.

8. In a wireless remote control system for controlling power distribution to a plurality of computers, the combination comprising:
a master controller computer for generating power distribution signals wherein each such signal is uniquely addressed to one of the plurality of computers;
a wireless signal receiver for receiving power distribution signals;
a wireless signal transmission link delivering power distribution signals from said master controller to said wireless signal receiver;
a plurality of external power switches, one said external power switches disposed between a power source and each of the computers, each said external power switches having an open condition in which the power source is disconnected from one of the computers and a closed condition in which the power source is connected to one of the computers;
an intelligent agent that receives signals from said wireless signal receiver, said intelligent agent having a plurality of two-way communication links, one between said intelligent agent and each of the plurality of computers, said intelligent agent having a communication link with each of said external power switches, wherein said intelligent agent can distribute control signals to and receives signals from each of the plurality of computers according to the address information in the signals from said master controller computer and controls the condition of said power switches.

9. The system of claim 8 wherein said two-way communication links between said intelligent agent and the plurality of computers is wireless.

10. The system of claim 8 further comprising a database of information about the plurality of computers and used by said master controller computer to generate a computer shutdown control signal that is addressed to one of the plurality of computers and recognized by that computer.

11. The system of claim 10 wherein each of the plurality of computers responds to a computer shutdown signal by executing an orderly shutdown routine and then transmitting a signal indicating that it is safe to disconnect the power source from that computer, which signal is transmitted to said intelligent agent over the two-way communication link.

12. The system of claim 11 wherein said intelligent agent responds to a signal from one of the plurality of computers that it is safe to disconnect the power source from that computer by opening said external power switch between that computer and the power source and thereby disconnecting the power source from that computer.

13. The system of claim 12 wherein at least one or more of the plurality of computers includes an internal power switch that is manually closed to connect power to the controlled computer and includes ACPI which, unless disabled, causes the internal power switch to open automatically after the computer executes its orderly shutdown routine, but which, if disabled, does not automatically open the internal power switch after the computer executes its orderly shutdown routine, but rather issues a signal indicating that it is safe to disconnect that computer from the power source and further comprising:
said master controller transmitting an ACPI disabling signal along with any shutdown signal to any of the plurality of computers having ACPI.

14. The system of claim 12 wherein control signals transmitted by said master controller computer include security information identifying the control signal as an authorized signal and said intelligent agent only distributes a control signal to one of the plurality of computers if the security information is authentic.

15. The system of claim 8 wherein said power switches are located at the power source and are wirelessly controlled by said intelligent agent.

16. The system of claim 9 wherein said power switches are located at the power source and are wirelessly controlled by said intelligent agent.

17. The system of claim 13 wherein said power switches are located at the power source and are wirelessly controlled by said intelligent agent.

18. A method of wirelessly controlling one or more remote devices to be controlled, including the steps of:
providing a database with specific information relating to each device to be controlled;
generating a device control signal using information from the database;
wirelessly transmitting the device control signal to a satellite;
wirelessly transmitting the device control signal from the satellite to a control signal transceiver;
distributing the control signal from the transceiver to the device to be controlled;
transmitting a signal from the device to be controlled to the transceiver indicating that the device to be controlled is ready to be controlled;
generating a signal that controls some aspect of the device to be controlled.

19. A method of wirelessly controlling one or more remote devices to be controlled, including the steps of:
generating a device control signal;
wirelessly transmitting the device control signal to a satellite;
wirelessly transmitting the device control signal from the satellite to a control signal transceiver;
distributing the control signal from the transceiver to the device to be controlled;
transmitting a signal from the device to be controlled to the transceiver indicating that the device to be controlled is ready to be controlled;
generating a signal that controls some aspect of the device to be controlled.

20. A method of wirelessly controlling power distribution to a plurality of computers each of which is connected to a power source, including the steps of:
generating power distribution control signals addressed to one or more of the plurality of computers;
wirelessly transmitting the power distribution control signals to a satellite;
wirelessly transmitting the power distribution control signals from the satellite to a control signal receiver;
distributing control signals from the control signal receiver to an intelligent agent;
transmitting over a two-way communication link a control signal from the intelligent agent to each of the plurality of computers addressed by the signal;
receiving a safe-to-shut-down signal by the intelligent agent over the two-way communication link from one of the plurality of computers receiving a control signal;
disconnecting from its power source each computer from which a safe-to-shut-down signal is received by the intelligent agent.

21. The method of claim 20 wherein the power distribution control signals include a ACPI disabling signal.

22. The method of claim 20 wherein the power distribution control signals include security information.

23. The method of claim 20 wherein transmissions over the two-way communication link are wireless.

24. The method of claim 20 wherein the last step recited includes transmitting a wireless signal.

25. In a wireless remote control system for controlling power distribution to a plurality of computers wherein the computers include wireless controlled internal power relay switches, the combination comprising:
a master controller computer for generating power distribution signals wherein each such signal is uniquely addressed to one of the plurality of computers;
a wireless signal receiver for receiving power distribution signals;
a wireless signal transmission link delivering power distribution signals from said master controller to said wireless signal receiver;
an intelligent agent that receives signals from said wireless signal receiver and distributes them to the computer to which they are addressed and to the internal power switch of the computer addressed.

26. The system of claim 25 wherein the signals transmitted to the wireless signal receiver include computer shutdown signals and computer startup signals.
